(19) United States
(12) Patent Application Publication
(10) Pub. No.: US 2013/0145260 A1
(43) Pub. Date: Jun. 6, 2013

(54) INFORMATION PROCESSING APPARATUS AND CONTROL METHOD FOR CREATING AN ALBUM

(71) Applicant: CANON KABUSHIKI KAISHA, Tokyo (JP)

(72) Inventor: Masaji Munekuni, Kawasaki-shi (JP)

(73) Assignee: CANON KABUSHIKI KAISHA, Tokyo (JP)

(21) Appl. No.: 13/693,950

(22) Filed: Dec. 4, 2012

(30) Foreign Application Priority Data
Dec. 6, 2011 (JP) 2011-266745

(51) Int. Cl. G06F 17/20

(52) U.S. Cl. CPC G06F 17/20
USPC 715/255

(57) ABSTRACT

An information processing apparatus for creating an album, the information processing apparatus including a relationship acquisition unit configured to acquire a relationship between a user and other persons, and a determination unit configured to determine at least one of a design, a number of pages, a number of images, and a binding of the album, at least subject to a relationship between the user and the other persons.

This application claims priority from Japanese Patent Application No. 2011-266745 filed Dec. 6, 2011, which is hereby incorporated by reference herein in its entirety.

### BACKGROUND OF THE INVENTION

1. Field of the Invention

The present disclosure generally relates to information processing and, more particularly, to an information processing apparatus and control method for creating an album.

2. Description of the Related Art

In recent years, a service for creating contents such as an album or a slide show using images uploaded via a network has come into widespread use. Along with the widespread use of such a service, chances for a user who creates an album to provide the created album to other persons have increased. However, considerable effort and time is normally involved if a plurality of types of albums is created according to a person who views the album, for example, in consideration of the personal relationship between persons who appear on images. A technique for assisting creation of such an album that takes into account the personal relationship between persons is discussed.

For example, according to Japanese Patent Application Laid-Open No. 2006-293986, an album is created by laying out images on which a main object is captured and images on which persons related to the main object is captured within the same page. According to Japanese Patent Application Laid-Open No. 2006-295889, and Japanese Patent Application Laid-Open No. 2006-236267, an album is created in which a designated person such as an album viewer and a person or an object related thereto are emphasized by laying out in the center of a page or in a large size.

The above-described album creation services normally charge a fee to a user according to a number of pages and a size that composes the created album. Therefore, in a case where the user creates a plurality of types of albums depending on persons who view the album, the user needs to create the albums taking their costs into account as well.

In the above-described known techniques, the album created to include images which the album viewer desires, however composition of the album such as a number of pages or a number images to be used based on the album viewer is not taken into account.

### SUMMARY OF THE INVENTION

According to some embodiments of the present disclosure, in an information processing apparatus for creating an album, the information processing apparatus includes a relationship acquisition unit configured to acquire a relationship between a user and another person, and a determination unit configured to determine at least one of a design, a number of pages, a number of images, and a binding of the album, with at least a relationship between the user and the other person as a condition.

Further features and aspects of the present disclosure will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the disclosure and, together with the description, serve to explain the principles of the disclosure.

FIG. 1 illustrates a configuration of an apparatus according to an exemplary embodiment.

FIG. 2 illustrates a configuration of a network according to the exemplary embodiment.

FIG. 3 illustrates an example of a screen to be displayed in an image sharing service.

FIG. 4 illustrates an example of a page in an album.

FIG. 5 is a flowchart illustrating an entire processing of an album creation.

FIG. 6 is a flowchart illustrating image layout processing.

FIG. 7 is a flowchart illustrating main image determination processing.

FIG. 8 is a flowchart illustrating sub image determination processing.

FIG. 9 is a flowchart illustrating album composition determination processing.

FIG. 10 illustrates a functional configuration of a server according to the exemplary embodiment.

### DESCRIPTION OF THE EMBODIMENTS

Various exemplary embodiments, features, and aspects of the disclosure will be described in detail below with reference to the drawings.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Respective exemplary embodiments described below aim to automatically create an album suitable for a person who views the album.

According to a first exemplary embodiment, a content creation system for creating an album using images stored on a server and information of users will be described.

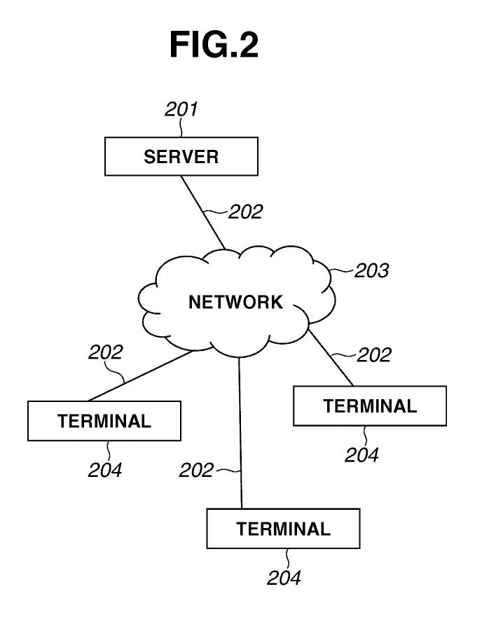

A system configuration of the content creation system in the present exemplary embodiment is illustrated in FIG. 2. In FIG. 2, a server 201 serves as an information processing apparatus that manages images uploaded from each terminal apparatus 204 which a user operates, and provides to the user a service for creating an album using these images. The server 201 and the terminal apparatus 204 are connected to a network 203 via a wired or wireless network interface 202 for connecting to the network, and are configured to be capable of communicating with each other. Accordingly, the content creation system provided by the server 201 can be utilized by the terminals 204 via the network 203. The system configuration illustrated in FIG. 2 is only an example and the content creation system is not limited to this configuration. For example, the content creation system in FIG. 2 includes one server 201 and three terminals, however, an operation of the server 201 may be executed by a plurality of apparatuses, and also a number of the terminals is not limited. Further, an operation in the content creation system may be realized by a single apparatus.

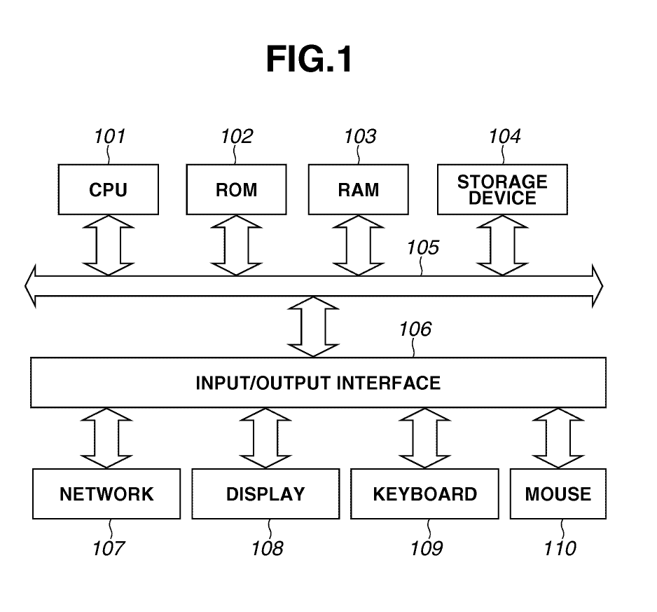

A hardware configuration of the server 201 and the terminals 204 according to the present exemplary embodiment will be described with reference to the block diagram in FIG. 1. In FIG. 1, a central processing unit (CPU) 101 controls respective devices connected to the CPU device based on a control program stored in a read only memory (ROM) 102 or a storage device 104 described below. An operation of each apparatus in the present content creation system described below is realized by causing the CPU 101 of each apparatus to execute a control program stored in the ROM 102 or the storage device 104. The ROM 102 stores various types of control programs and data. A random access memory (RAM) 103 includes a work area for the CPU 101, a save area of data at the time of error processing, and a load area of the control programs.

The storage device 104 stores various types of control programs and data pieces. In the storage device 104 in the server 201, images uploaded by users and templates to be used in album creation are stored. An input/output interface 106 performs control of various types of devices, and input/output of data. A CPU bus 105 includes an address bus, a data bus, and a control bus, and connects each hardware. The CPU 101 can communicate with other apparatuses via a network 107. Control programs provided to the CPU 101 from the ROM 102 or the storage device 104. In addition, the control programs acquired from an external apparatus via the network 107. A display 108 displays various types of data. A keyboard 109 detects an operation input to the apparatus from the user. A mouse 110 detects an operation input to the apparatus from the user.

According to the present exemplary embodiment, an information processing program code for realizing operations of respective apparatuses described below is stored in the storage device 104, and is executed by the CPU 101. The user operates the apparatus using the keyboard 109 and the mouse 110, and sees results on the display 108. The mouse 110 may be a pointing device such as a trackball or a touch panel as long as it allows the user to input an instruction on a screen.

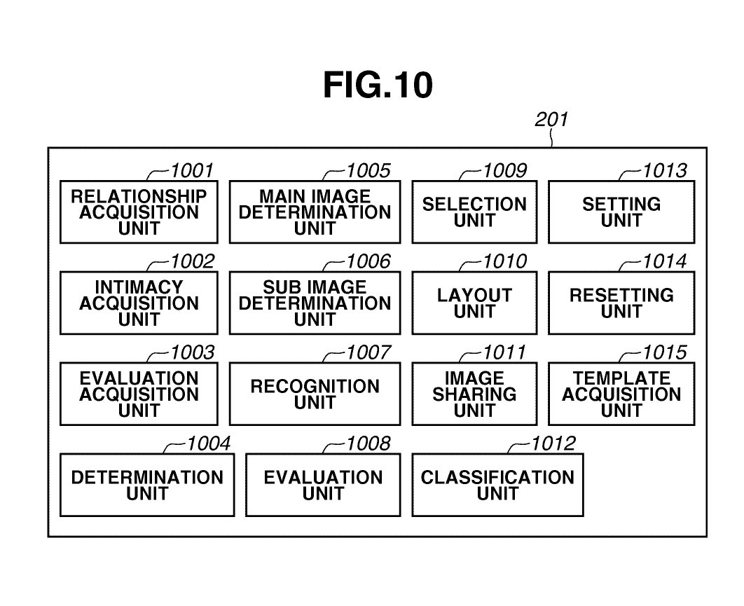

A functional configuration of the server 201 will be described with reference to FIG. 10. A relationship acquisition unit 1001 acquires a relationship between users (between persons). An intimacy acquisition unit 1002 acquires intimacy which is a degree of intimacy between users (between persons). An evaluation acquisition unit 1003 acquires an evaluation which is assigned to an image. A determination unit 1004 determines an album composition to be created according to a relationship between the users. The album composition refers to elements for composing an album, such as a design, a number of pages, a number of images, and a binding method. A main image determination unit 1005 determines whether an image is important for an album to be created and is appropriate as a major image (main image).

A main image may be laid out each one frame in one page in the album, and is laid out in larger size than other images to be laid out in the one page or in the center to be distinctive. A sub image determination unit 1006 determines whether an image is appropriate as the image to be inserted into the album (sub image) although it is not so important as a main image. The sub image is laid out in smaller size than the main image. A recognition unit 1007 detects and identifies a predetermined object from the image. An evaluation unit 1008 evaluates an image based on whether the image should be used in the album. A selection unit 1009 selects an image to be used in the album.

A layout unit 1010 lays out the images to create the album. An image sharing unit 1011 releases an image uploaded from a user to other users. Further, the image sharing unit 1011 acquires comments and evaluations to the released image, and stores the comments and evaluations by associating with the image. A classification unit 1012 classifies users into groups according to a relationship with an album creator. A setting unit 1013 sets an album creator and an album viewer who is a user who is presented and views the created album. The album viewer is a target to whom the album created by the album creator is presented regardless of whether the album viewer actually views the album. A resetting unit 1014 resets the number of pages or the number of images, if images to be used in the album are short in the number of pages or the number of images determined by the determination unit 1004. A template acquisition unit 1015 acquires a template based on the determined album composition.

The content creation service that is provided to the terminal 204 on the server 201 will be described. The server 201 provides an image sharing service for sharing images uploaded from the user so that other users can view them, as a part of the content creation service. Images, comments, and messages can be shared among a plurality of users as described below by a program running on the server 201.

First, each user registers account information to the server 201, in order to utilize the content creation service and the image sharing service provided by the server 201. The user can use the content creation service by inputting the registered account information and logging in from the terminal 204. The user who has logged in from the terminal 204 to the server 201 sets a profile relating to the user including a user's facial image to be stored in association with the account information. The user can upload a plurality of images. The uploaded profile and images are stored in the server 201. The logged in user can refer to the own profile and images stored in the server 201 and also profiles and images of other users.

In addition, the user can assign a comment, a keyword, and an evaluation to each viewable image. The comment, the keyword, and the evaluation assigned to the image are stored in the server 201 in association with the image. An arbitrary statement can be input to the image as a comment. The keyword selected from a plurality of words after designating the image. The evaluation is set by pressing a “like!” button displayed near the image. The logged in user can refer to the image stored in the server 201 and the comment, the keyword, and the evaluation assigned to the image. On the image sharing service, users can send and receive a message therebetween. A communication record of messages is stored in the server 201.

An arbitrary user can set “relative”, “friend”, or “acquaintance” relationship (main relationship) to other users. Sub relationship obtained by subdividing the main relationship set. For example, to the main relationship “relative”, sub relationships of “parent-child”, “sibling”, “grandparent-grandchild”, “uncle/aunt-niece/cousin”, and “other relative” set. To the main relationship “friend”, sub relationships of “close friend”, “schoolmate”, “co-worker”, “community”, and “other friend” set. To the main relationship “acquaintance”, sub relationships of “schoolmate”, “co-worker”, “community”, and “other acquaintance” set. If a relationship is not set between users, the server 201 sets the relationship between these users as “other people”. The main relationship “other people” has no sub relationships.

In order for the user to set a relationship with other user, a notification is sent to the other user to whom the relationship is set, and if the other user who has received the notification clicks on an approval button, the relationship between the users is set. The server 201 manages the images uploaded by the image sharing service and the information obtained by the image sharing service. More specifically, the relationship acquisition unit 1001 acquires a relationship between users (between persons) according to the information formed based on utilization of the predetermined service on the network.

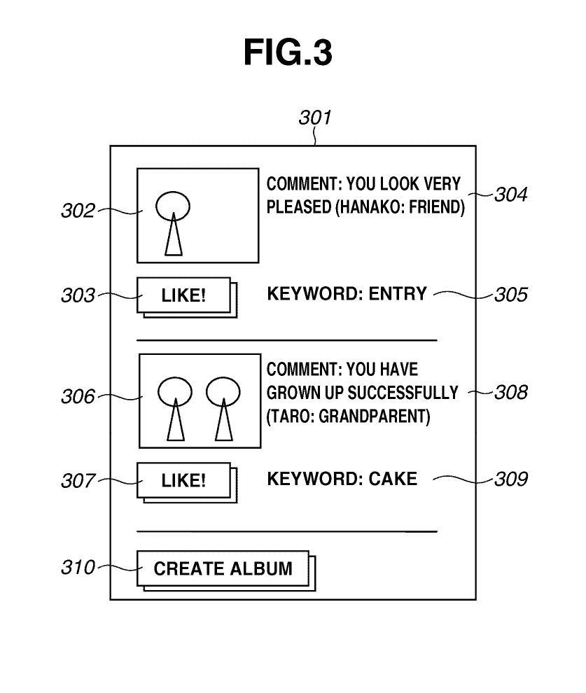

FIG. 3 illustrates an example of a display on a screen of the terminal 204 which utilizes the content creation service provided by the server 201. On a screen 301, two images 302 and 306 are displayed from among a plurality of images which the user has uploaded on the server 201. Users other than the user who has uploaded the images can also view the image 302 and the image 306 after logging in. The screen 301 includes an evaluation button 303 for assigning an evaluation to the image 302, and an evaluation button 307 for assigning an evaluation to the image 306. By pressing these buttons, the user of the content creation system can give evaluations to the images.

The user of the content creation system can also input a comment 304 and a keyword 305 to the image 302, and a comment 308 and a keyword 309 to the image 306. When the user of the content creation system inputs a comment, a username and a relationship between the user who has uploaded the image and the user who has input the comment are displayed together with the input comment. If the user who creates the album utilizing the content creation system presses a button 310 for starting the album creation in FIG. 3, the album creation is started.

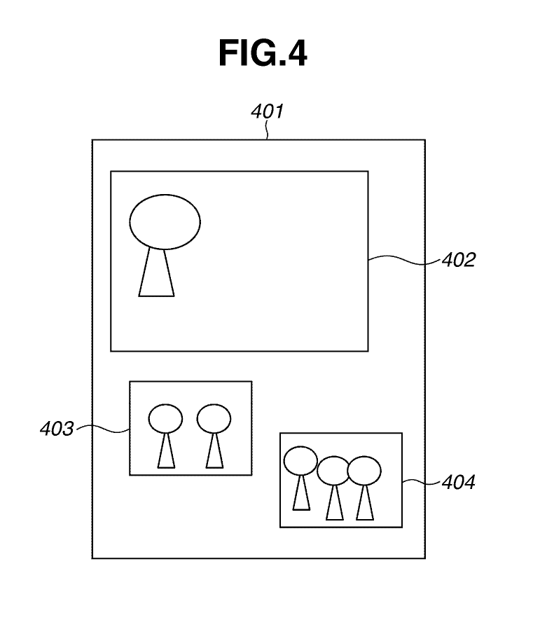

An example of a page in an album created by the server 201 is illustrated in FIG. 4. A template for arranging images in an album is prepared in advance for the album creation. The album template includes at least one or a plurality of pages. Each page includes one or a plurality of image insertion frames into which an image is inserted, and each image insertion frame is set with its position and size. The template may include a page with no image insertion frame, which is composed of only an album title or an image for decoration.

The image insertion frame includes a main image insertion frame and a sub image insertion frame. Assuming that the main image, which is of high importance for the album, is inserted into the main image insertion frame, the main image insertion frame is arranged in the center of the page or is configured to be larger in size than the sub image insertion frame. It is assumed that the sub image whose importance is not so high as the main images is inserted into the sub image insertion frame. Normally, the main image insertion frame is arranged with a size and at a position more noticeable than the sub image insertion frame. At least one of the image insertion frames set in each page of the album template is the main image insertion frame.

If there is no image to be inserted, a substitute for an image inserted into the image insertion frame. For example, a plurality of illustrations corresponding to a theme of the album (wedding ceremony in the present exemplary embodiment) may be prepared. Alternatively, a message or an illustration for decoration may be included in a region other than the image insertion frame of the template. The template according to the present exemplary embodiment is stored in association with information related to composition, such as a number of pages, number and position of the image insertion frames, and types of the image insertion frames. The server 201 manages the composition of each template based on the composition information associated with each template. FIG. 4 illustrates an example of a page 401 of the created album. In the page, a main image insertion frame 402, sub image insertion frames 403 and 404 for inserting images therein are set.

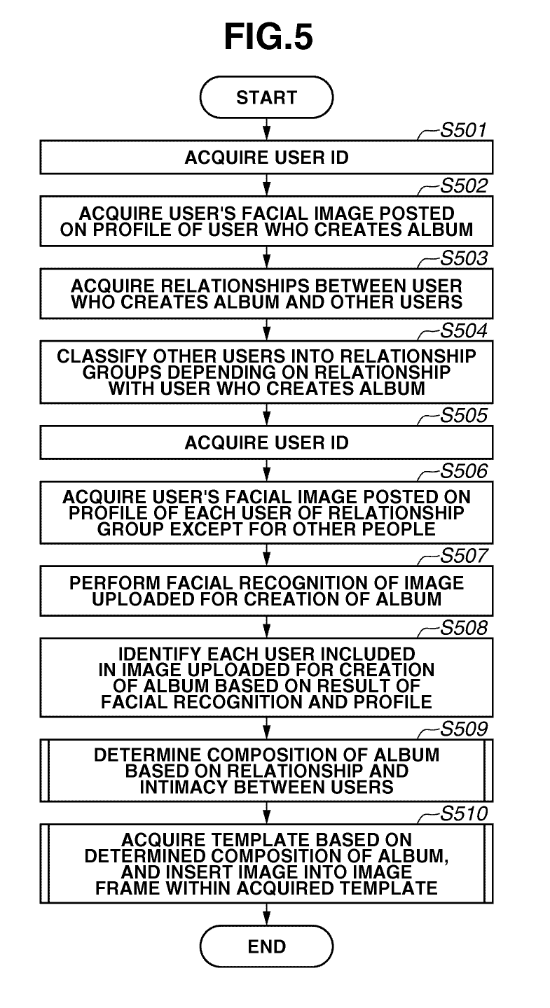

Next, album creation processing executed by the server 201 will be described with reference to flowcharts in FIG. 5 to FIG. 9. The server 201 creates an album using images uploaded for album creation by a user who creates the album (i.e., album creator) and information stored in response to utilization of the image sharing service by the user. The server 201 creates an album corresponding to a “user who views the album”, which is set by the user as a target who gets to view the created album.

FIG. 5 is a flowchart illustrating entire processing of the album creation. Upon detecting pressing of the button 310 for creating the album illustrated in FIG. 3 by the user who creates the album, the server 201 starts the processing in the flowchart in FIG. 5. In step S501, the server 201 acquires identification (ID) of a user who creates the album. The server 201 acquires the account information of the user who creates the album.

In step S502, the server 201 acquires a user's facial image posted on a profile of the user who creates the album. In the content creation system according to the present exemplary embodiment, each user may upload own introduction statement and a facial image as the profile. The server 201 acquires the facial image of the user who creates the album from the images posted on the profile which the user who creates the album has uploaded.

In step S503, the relationship acquisition unit 1001 acquires relationships between the user who creates the album and other users of the content creation system. More specifically, the relationship acquisition unit 1001 acquires main relationships of “relative”, “friend”, “acquaintance”, and “other people” and their sub relationships, which are set between the user who creates the album and the other users.

In step S504, the classification unit 1013 classifies the other users into groups according to the relationship with the album creator. As the groups to be classified, the main relationship groups may be classified into a “relative” group, a “friend” group, an “acquaintance” group, and an “other people” group according to the main relationship of the other users with the user who creates the album. As the groups to be classified, each main relationship group may be further classified into sub relationship groups according to the sub relationship of the other users with the user who creates the album. The sub relationship groups into which the main relationship group “relative” group is further classified may include a “parent-child” group, a “sibling” group, a “grandparent-grandchild” group, an “uncle/aunt-niece/cousin” group, and an “other relative” group. The sub relationship groups of the main relationship group “friend” group may include a “close friend” group, a “schoolmate” group, a “co-worker” group, a “community” group, and an “other friend” group. The “acquaintance” group may include “a schoolmate” group, a “co-worker” group, a “community” group, and an “other acquaintance” group. The “other people” group does not include any sub relationship group.

In step S505, the server 201 acquires ID of a user who views the album. More specifically, the server 201 transmits a list of usernames and profiles of the other users who have relationships with the user who creates the album to the terminal 204 corresponding to the user who creates the album. The user who creates the album selects a user who views the album from among a displayed list of the users. The server 201 identifies the user who views the album selected by the user from a message returned from the terminal 204. The server 201 is supposed not to create a list of usernames and profiles relating to the other users who are set to the “other people group”, so as not to make them selection candidates for a “user who views the album”.

In step S506, the setting unit 1014 acquires facial image of the user posted on the profile of each user in the relationship group except for “other people”. Next, in step S507, the recognition unit 1007 performs face recognition on an image to be used for the album creation which the user who creates the album has uploaded, using the facial image acquired in step S502 and the facial image acquired in step S507.

In step S508, the recognition unit 1007 identifies a person included in the image uploaded for the album creation based on a result of the face recognition in step S507. In step S509, the determination unit 1004 determines a composition of the album to be created based on the relationship and the degree of intimacy between the users. As an album composition to be determined, the determination unit 1004 determines at least one of a number of pages, a design of the album, a binding method, a size, a number of image insertion frames. Each item to be determined in the album composition determination processing will be described.

As for the number of pages of an album, generally, an album is often composed with about 20 pages. Thus, according to the present exemplary embodiment, as the number of pages of the album to be composed, the number of pages is set into three ranks, i.e., “small” indicates 10 pages, “normal” indicates 20 pages, and “many” indicates 40 pages, according to the relationship.

As a binding method, a type of an outer covering of the album is set. According to the present exemplary embodiment, it is supposed to set a hard cover or a soft cover. Design is used to set a theme such as a pattern, a shape, a color of the entire album, and “pop”, “chic”, or “classic” set, in the present exemplary embodiment. “Pop” features brilliant colors and decoration to be applied in whole. “Chic” features a simple design in muted color with less decoration, such as illustration. “Classic” features an intermediate position between “pop” and “chic”. A template for inserting images is associated with the design, and decoration along with the design is applied to each template. The size is used to set a physical size per page, and in the present exemplary embodiment, any of three ranks, “large”, “medium”, or “small” may be set. The price for printing the album will increase as the number of pages increase, the binding with the hard cover is selected, and the size is lager.

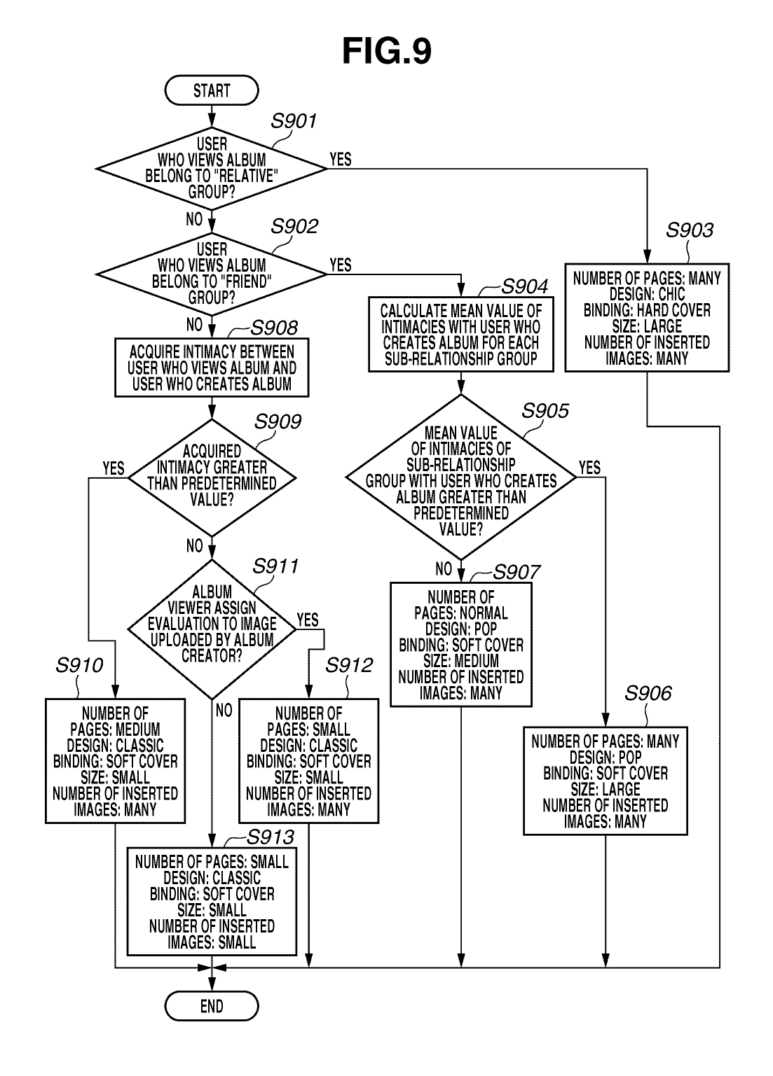

The details of the album composition determination processing in step S509 will be described with reference to the flowchart illustrated in FIG. 9. As illustrated in FIG. 9, in step S901, the determination unit 1004 determines whether the user who views the album belongs to the “relative” main relationship group. If the user who views the album belongs to the “relative” main relationship group (YES in step S901), the processing proceeds to step S903. In step S903, the determination unit 1004 determines to create, for the user who views the album set in the current processing, the album in a composition which includes a “many” number of pages, uses a hard cover as the binding method, is “chic” in design, “large” in size, and includes “many” image insertion frames are included on a page. If there is an occasion to present an album to a relative, the album may be considered as the one for a special event such as a celebration like a wedding ceremony and an anniversary as assumed in the present exemplary embodiment. Therefore, the album composition as indicated in step S903 is automatically determined so that an album in gorgeous and handsome composition will be created to the relative even if it is expensive.

On the other hand, if the user who views the album does not belong to the “relative” main relationship group (NO in step S901), the processing proceeds to step S902. In step S902, the determination unit 1004 determines whether the user who views the album belongs to the “friend” main relationship group. If the user who views the album belongs to the “friend” main relationship group (YES instep S902), the processing proceeds to step S904. Whereas, if the user who views the album does not belong to the “friend” main relationship group (NO in step S902), the processing proceeds to step S908.

In step S904, the intimacy acquisition unit 1002 acquires the degree of intimacy between each of all users who belong to the main relationship “friend” and the user who creates the album. Then, the intimacy acquisition unit 1002 calculates, for each sub relationship group of the main relationship “friend”, a mean value of the degree of intimacy between the users who belong to the group and the user who creates the album. The degree of intimacy is calculated according to a number of messages exchanged between the user who creates the album and other users, and a number of evaluations or comments assigned to each other's images between the users. The more the number of sending and receiving of messages exchanged between the users, the higher (the more intimate) the degree of intimacy is calculated. The more the number of evaluations or comments are assigned to each other's images between the users, the higher (the more intimate) the degree of intimacy is calculated. The determination unit 1004 further calculates, for each sub relationship group, a mean value of the degree of intimacy of the users whose main relationship is “friend” using the degree of intimacy calculated in this way.

Then, in step S905, the server 201 determines whether a mean value of the degree of intimacy of the sub relationship group to which the user who views the album belongs is greater than a predetermined value. The predetermined value in the present exemplary embodiment may be a mean value of the degree of intimacy of all the users whose main relationship is “friend”. If the mean value of the degree of intimacy of the sub relationship group to which the user who views the album belongs is greater (YES in step S905), the processing proceeds to step S906, and whereas if not (NO in step S905), the processing proceeds to step S907.

In step S906, the determination unit 1004 determines to create, for the user who views the album set in the current processing, the album in the composition which includes a “many” number of pages, uses a soft cover as the binding method, is “pop” in design, “large” in size, and includes “many” image insertion frames. In step S907, the determination unit 1004 determines to create, for the user who views the album set in the current processing, the album in the composition which includes a “normal” number of pages, uses a soft cover as the binding method, is “pop” in design, “medium” in size, and includes “many” image insertion frames.

As described above, if a relationship between the user who creates the album and the user who views the album is the main relationship “friend”, the album compositions for the users who view the album and belong to the same sub relationship are the same. Therefore, if the albums are created for a plurality of persons, inequality due to difference in the album composition does not occur at least among the users of the same sub relationship. If the album viewer belongs to a relationship having regularly intimate contact with the album creator, the album may be created with the increased number of pages. By composing the album which includes “many” number of pages, images which the album viewer who belongs to a highly intimate relationship would want to view can be posted with less omission. This is because the user who views the album is in the relationship having regularly intimate contact with the album creator, and there is a possibility that the album viewer himself or herself or other persons who belong to the same sub relationship as the album viewer appear on the uploaded images more frequently. Thus, the album can be composed so that images, which the album viewer would want to view, appear without omission.

On the other hand, in step S902, if the user who views the album does not belong to the “friend” group (NO in step S902), the processing proceeds to step S908. In step S908, the intimacy acquisition unit 1002 acquires a degree of intimacy between the user who views the album and the user who creates the album. The degree of intimacy is calculated as described in step S904.

In step S909, the server 201 determines whether the degree of intimacy between the user who views the album and the user who creates the album is greater than a predetermined value. The predetermined value may be a mean value of the degree of intimacy of all users who have relationship with the user who creates the album, except for other people group. If the degree of intimacy between the user who views the album and the user who creates the album is greater than the mean value of the degree of intimacy of all users (YES in step S909), the processing proceeds to step S910, or if not (NO in step S909), the processing proceeds to step S911.

In step S910, the determination unit 1004 determines to create, for the user who views the album set in the current processing, an album in the composition which includes a “medium” number of pages, uses a soft cover as the binding method, is “classic” in design, “small” in size, and includes “many” image insertion frames.

In step S911, the evaluation acquisition unit 1003 determines whether the album viewer assigns an evaluation to an image uploaded by the album creator. If the album viewer assigns an evaluation to an image uploaded by the album creator (YES in step S911), the processing proceeds to step S912. Whereas if not (NO in step S911), the processing proceeds to step S913.

In step S912, the determination unit 1004 determines to create, for the user who views the album set in the current processing, the album in the composition which includes a “small” number of pages, uses a soft cover as the binding method, is “classic” in design, “small” in size, and includes “many” image insertion frames. The user who views the album set in the current processing is not a relative, a friend, or a user with a high degree of intimacy, but has a strong interest in the images. Thus, the album composition may be set to create the album including many image insertion frames so that as many images as possible appear on the album while keeping the cost for the album creation down.

On the other hand, in step S913, the determination unit 1004 determines to create, for the user who views the album set in the current processing, the album in the composition which includes a “small” number of pages, uses a soft cover as the binding method, is “classic” in design, “small” in size, and includes “small” image insertion frames. Since the user who views the album set in the current processing is not a relative, a friend, or a user with a high degree of intimacy, images to be posted (images in which the person or an acquaintance is captured) on the album for the user are thought to be small in number. Therefore, the determination unit 1004 determines to compose the album with a small number of inserted images.

As described above, the determination unit 1004 determines a number of pages, a design of the album, a binding method, a size, and a number of image insertion frames, according to a relationship between the user who creates the album and the user who views the album. Therefore, according to the relationship between the user who creates the album and the user who views the album, the album that takes cost into account can be automatically created. For example, in a case where an album is presented to a relative, the album with a solid binding that remains as a memory can be automatically created. In addition, the album in the same composition can be created at least for users who belong to the same relationship with respect to the user who creates the album so that inequality occurs as little as possible between friends.

The album composition is determined according to a degree of intimacy with the user who creates the album. Therefore, for example, for a viewer who is likely to appear on images owned by the user who creates the album, the album composition may be set to post these images on the album without omission. If the degree of intimacy between the album viewer and the album creator is low, the album composition may be set to include an increased number of images while keeping down the album creation cost for a person who takes an interest in the images themselves of the creator.

Returning to FIG. 5, after the album composition is determined, in step S509, the server 201 acquires a template to create an album based on the determined album composition. For example, the server 201 acquires a template corresponding to the determined design. The server 201 acquires a template that realizes the determined number of pages and the number of image insertion frames. The templates to be acquired may be plural as long as the template can realize the determined album composition. Then, the server 201 lays out the selected images on the acquired template. The server 201 selects and lays out the images to be used in the album. In step S510, the server 201 inserts the images selected based on the relationship, and degree of intimacy between the users, and evaluations to the images into the image insertion frames in the template.

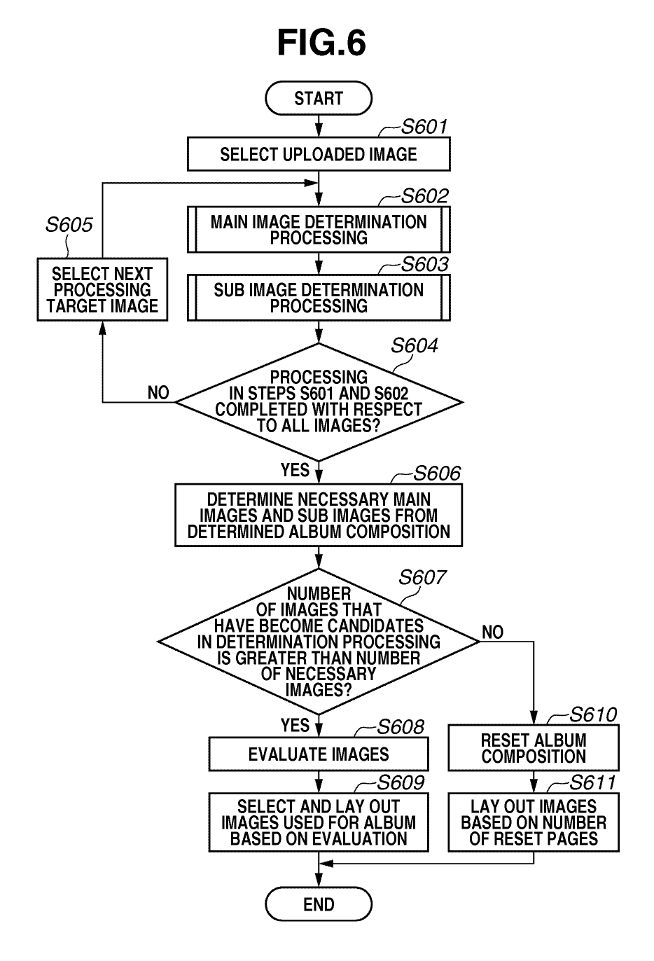

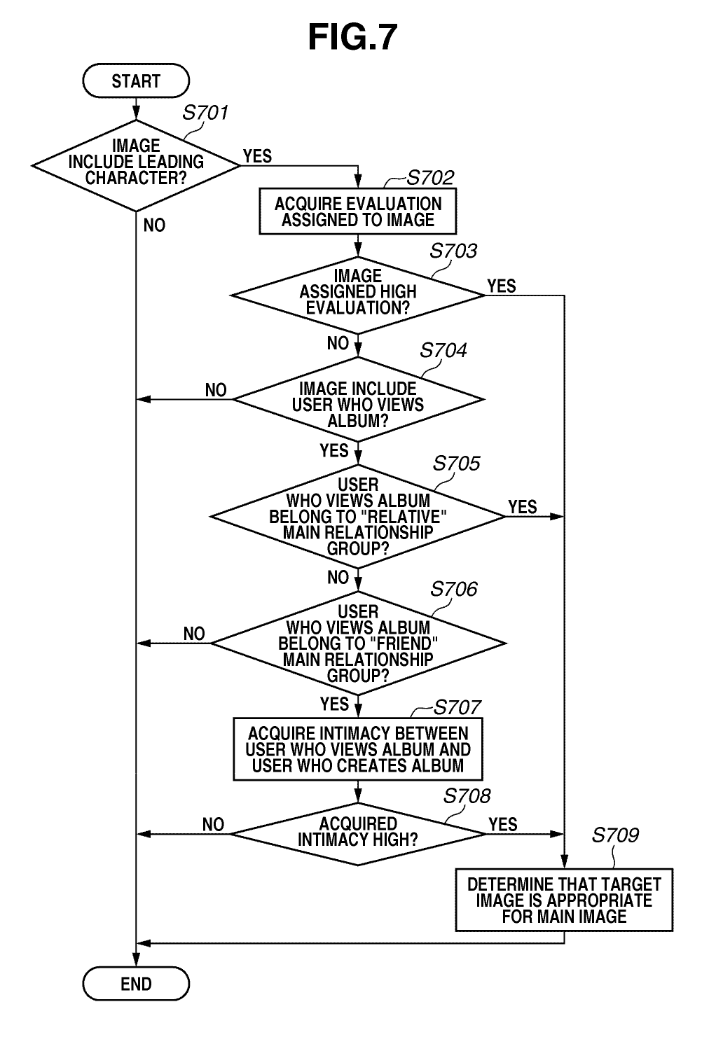

FIG. 6 is a flowchart illustrating in detail the processing in step S510. In step S601, the album creator selects any one of the uploaded images as a processing target image. In step S602, the main image determination unit 1005 determines whether the image selected as the processing target image is suitable for a main image. The details of the processing in step S602 will be described with reference to FIG. 7.

FIG. 7 is a flowchart illustrating the processing for determining whether the selected image is an appropriate image as a main image to be laid out in the album, based on the relationship, the degree of intimacy between the viewer and the creator, and the evaluation to the image. The main image is an important and major image in the album. In a case where an album for a wedding ceremony and a wedding reception is created according to the present exemplary embodiment, it can be appropriate to mainly insert images of a gloom and a bride, namely the users who create the album. In a case where the user who views the album is intimately related to the user who creates the album, such as a relative or a close friend, it is also desirable to insert images including both the user who views the album and the user who creates the album. On the other hand, in a case where the degree of intimacy between the user who creates the album and the user who views the album is not high, the main image is desirable to be selected from an image which does not includes the both users.

In step S701, the recognition unit 1007 determines whether an image includes a person who is a leading character in the processing target image. The leading character is the album creator, namely the gloom or the bride of the wedding ceremony in the present exemplary embodiment. It is desirable that the leading character (main character) is included in the main image. In particular, in a case where photographs of the wedding ceremony are put together into the album as in the present exemplary embodiment, since the image of the main character of the wedding ceremony is an image which everybody wants to see, the image of the main character is suitable to be inserted into the main image insertion frame. The leading character may be set in advance in a similar way to the processing for setting the album viewer in step S505.

If the processing target image does not include the leading character (NO in step S701), the main image determination unit 1005 determines that an image of the processing target is not appropriate as the main image, and ends the processing. If the leading character (the user who creates the album) is included in the processing target image (YES in step S701), the processing proceeds to step S702.

In step S702, the evaluation acquisition unit 1003 acquires evaluations assigned to the processing target image. Actually, since it is troublesome to assign evaluations to every one of the images, it is hard to imagine that evaluations are assigned to all images. However, since it is thought that an evaluation is assigned to an image that should be definitely posted, it is desirable that the evaluation has priority. The evaluation is determined according to a number of presses of the “like!” button, or a number of comments input into the image.

Then, in step S703, the main image determination unit 1005 determines whether an evaluation of the processing target image is higher than a predetermined value. In step S703, if the evaluations of the processing target image are larger than a mean value of evaluations assigned to the images uploaded by the album creator, it is determined that the evaluation of the processing target image is high. Alternatively, it may be configured such that if the processing target image is evaluated by the album viewer, it is determined as a high evaluation. If the evaluation of the processing target image is higher than the predetermined value (YES in step S703), since the processing target image includes the user who creates the album and is highly evaluated, the main image determination unit 1005 determines that the processing target image is desirable as a main image. Then, the processing proceeds to step S709. In step S709, the main image determination unit 1005 attaches a flag to the processing target image indicating that it is appropriate for the main image, and ends the processing.

If the evaluation of the processing target image is not higher than the predetermined value (NO in step S703), the image includes the main character of the album but is not highly evaluated. However, since evaluation of an image requires time and effort, even an image to which the evaluation is not assigned may be a desirable image for the user who views the album in some cases.

In step S704, the recognition unit 1007 determines whether the image includes the user who views the album. If the image does not include the user who view the album (NO in step S704), the main image determination unit 1005 determines that, since the image does not include the user who views the album, the processing target image is not appropriate for the main image, and ends the processing. If the image includes the user who view the album (YES in step S704), there is a possibility that the image is appropriate as an image to be inserted into the main image insertion frame, and the processing proceeds to step S705 for further determination.

In step S705, the main image determination unit 1005 determines whether the user who views the album belongs to the “relative” main relationship group. If the user who views the album is the relative (YES in step S705), since the album is for the wedding ceremony, the main image determination unit 1005 determines that the image is appropriate as the main image, advances the processing to step S709, and ends the processing.

If the user who views the album is not the relative (NO in step S705), the processing proceeds to step S706. In step S706, the main image determination unit 1005 determines whether the user who views the album belongs to the “friend” main relationship group. If the user who views the album does not belong to the “friend” main relationship group (NO in step S706), the main image determination unit 1005 determines that the processing target image is not appropriate as the main image, and ends the processing. If the user who views the album belongs to the “friend” main relationship group (YES in step S706), the main image determination unit 1005 determines that both the album creator and the album viewer are included in the image, and the relationship between the users is friend. However, if a degree of intimacy of the users is not so high, even when the relationship is friend, the image is not suitable as the main image. Therefore, if the degree of intimacy of the users is high, it is desirable to insert the processing target image into the main image insertion frame.

In step S706, if the user who views the album belongs to the “friend” main relationship group (YES in step S706), the processing proceeds to step S707. In step S707, the intimacy acquisition unit 1002 acquires a degree of intimacy between the user who views the album and the user who creates the album. The degree of intimacy may be acquired from an exchange history of messages between the users, a comment entry to the image, and an evaluation to the image. If a number of messages exchanged between the user who creates the album and the user who views the album is larger than a mean value of total numbers of messages which the user who creates the album exchanged with other users, it is determined that the degree of intimacy is high. Further, if a number of pressing of the “like!” button by the user who views the album, or a number of comments input to the image is larger than a mean value of total numbers thereof, it is determined that the degree of intimacy with the user who views the album is high.

In step S708, the main image determination unit 1005 determines whether the acquired degree of intimacy is higher than a mean value of that of the other users. If the acquired degree of intimacy is not higher than the mean value of that of the other users (NO in step S708), the degree of intimacy between the user who views the album and the user who creates the album is not high. Therefore, the main image determination unit 1005 determines that an image that includes the both users is not desirable for the main image, and ends the processing. If the acquired degree of intimacy is higher than the mean value of that of the other users (YES in step S708), the processing proceeds to step S709. In step S709 the main image determination unit 1005 determines that the processing target image is appropriate for the main image, and ends the processing.

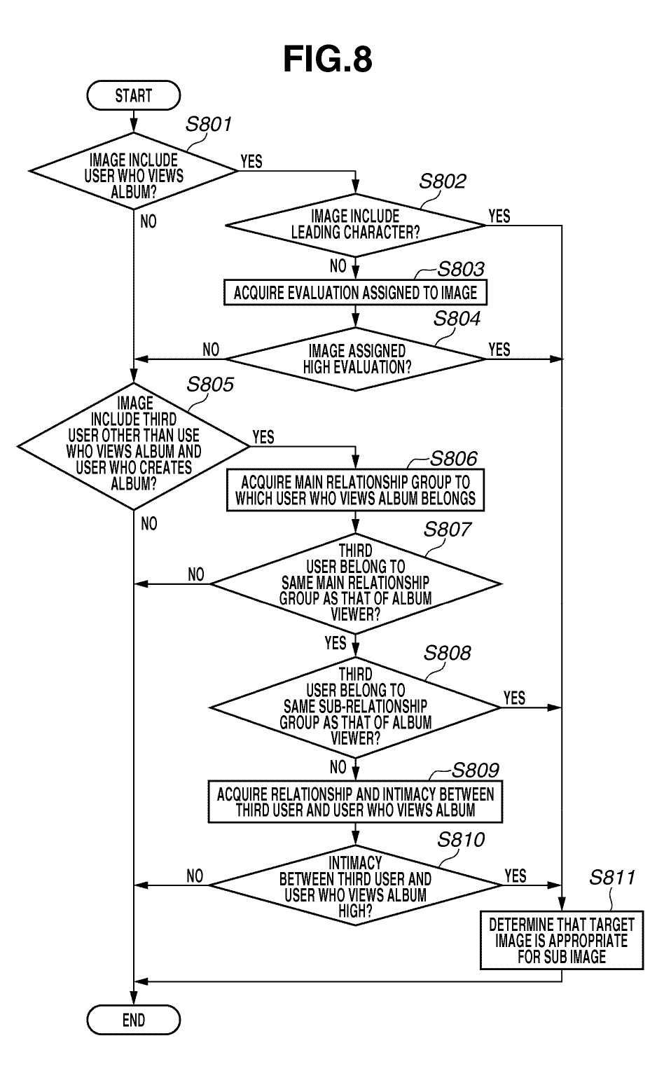

When the processing in the flowchart in FIG. 7 is ended, the processing returns to step S603 in FIG. 6. In step S603, the sub image determination unit 1006 determined whether the selected image is an image appropriate for the sub image based on the relationship and degree of intimacy between the users, and an evaluation to the image. The details of the processing in step S605 will be described with reference to FIG. 8.

A sub image is not so important as a main image, but it is desirable to insert an image in which the user who views the album takes an interest. As the sub image, it is desirable to insert an image that includes the user who views the album, and an image that includes the user who views the album together with the user who creates the album is suitable. In addition, as the sub image, it is also desirable to insert an image of a third user who is related to the user who views the album. For example, if the user who views the album is a grandfather of the gloom, it is desirable to include an image of the relatives in the images to be inserted into the sub image insertion frame. Further, if the user who views the album is the grandfather of the gloom, it is desirable that an image of strangers such as company co-workers or acquaintances of the gloom and bride is not posted in the album which can include only a limited number of images. In addition, it is desirable not to post an image of the third user who is less intimate with the user who views the album.

As the processing for determining whether the image is appropriate as the above-described sub image, first, in step S801, the recognition unit 1007 determines whether the processing target image includes the user who views the album. If the user who views the album is included (YES in step S801), the processing proceeds to step S802. Whereas, if not (NO in step S801), the processing proceeds to step S805.

In step S802, the recognition unit 1007 determine whether the image includes the leading character (the album creator in the present exemplary embodiment). If the leading character is included (YES in step S802), the image includes both the user who views the album and the user who creates the album. Thus, the processing target image is suitable as the sub image, and the processing proceeds to step S811. In step S811, the sub image determination unit 1006 attaches to the processing target image a flag indicating that the processing target image is appropriate as the sub image, and ends the processing.

If the leading character is not included in the image (NO in step S802), then in step S803, the evaluation acquisition unit 1003 acquires an evaluation assigned to the processing target image. Subsequently, in step S804, the evaluation acquisition unit 1003 determines whether the evaluation of the processing target image is higher than a predetermined value. In this process, if the evaluations of the processing target image are larger than a mean value of the evaluations assigned to other images, it is determined that the evaluation is high. If the evaluation of the image is high (YES in step S804), the processing target image is determined as appropriate for the sub image to be used in the album, and the processing proceeds to step S811. If the evaluation of the image is not high (NO in step S804), the processing proceeds to step S805.

In step S805, the recognition unit 1007 determines whether the processing target image includes a third user other than the user who views the album and the user who creates the album. If the third user is not included in the processing target image (NO in step S805), the recognition unit 1007 determines that the processing target image is not desirable as an image to be inserted into the sub image insertion frame, and ends the processing. If it is determined that the third user is included in the processing target image (YES in step S805), the processing proceeds to step S806. In step S806, the server 201 acquires the main relationship group to which the user who views the album belongs.

In step S807, the server 201 determines whether the third user belongs to the acquired main relationship group to which the album viewer belongs. If the third user does not belong to the main relationship group to which the album viewer belongs (NO in step S807), that is the third user belongs to a relationship different from the relationship of the album viewer and the album creator, there is a high possibility that the album viewer and the third user may have no contact with each other (have no relationship). Therefore, the server 201 determines that the processing target image is not appropriate for the sub image, and ends the processing. If the third user belongs to the main relationship group to which the album viewer belongs (YES in step S807), the processing proceeds to step S808.

In step S808, the server 201 determines whether the third user belongs to the same sub relationship of the album creator and the album viewer. Even if the user who views the album and the third user belong to the same type of the main relationship group, it is not always true that there is a relationship between the user who views the album and the third user. However, if the third user belongs to the same sub relationship of the album creator and the album viewer, it may be thought that the user who views the album is acquainted with the third user. Therefore, if it is determined that the third user belongs to the same sub relationship of the album creator and the album viewer (YES in step S808), the sub image determination unit 1006 determines that the processing target image is appropriate for the sub image because an album viewer's acquaintance is included in the processing target image, and the processing proceeds to step S811.

On the other hand, if it is determined the third user does not belong to the same sub relationship of the album creator and the album viewer (NO in step S808), the processing proceeds to step S809. In step S809, the sub image determination unit 1006 acquires a relationship and a degree of intimacy between the third user and the user who views the album.

In step S810, the sub image determination unit 1006 determines whether the degree of intimacy between the third user and the user who views the album is higher than a predetermined value. The degree of intimacy may be acquired from an exchange history of messages between the users, a comment entry to the image, and an evaluation to the image. If a number of messages exchanged between the user who views the album and the third user is larger than a mean value of total numbers of messages which the user who creates the album exchanged with other users, it is determined that the degree of intimacy is high. Further, if a number of pressing of the “like!” button by the user who views the album, or a number of comments input to the image is larger than a mean value of total numbers thereof, it is determined that the degree of intimacy with the user who views the album is high.

If it is determined that the degree of intimacy is not higher than the predetermined value (NO in step S810), it is determined that a person who is not intimate with the album viewer is included in the processing target image. Therefore, the sub image determination unit 1006 determines that the processing target image is not appropriate as the sub image, and ends the processing. On the other hand, if the degree of intimacy is higher than the predetermined value (YES in step S810), since the third user who is intimate with the user who views the album is included in the processing target image, the sub image determination unit 1006 determines that the processing target image is appropriate for the sub image, advances the processing to step S811, and ends the processing.

Returning to FIG. 6, in step S604, the server 201 determines whether the processing in steps S602 and S603 have been completed with respect to all images uploaded by the album creator. If the processing have not been completed with respect to all uploaded images (NO in step S604), in step S605, the server 201 selects a next processing target image from among the uploaded images, and performs the processing in steps S602 and S603. If the processing in steps S602 and S603 have been completed with respect to all uploaded images (YES instep S604), the processing proceeds to step S606.

In step S606, the server 201 determines a number of the main images and the sub images necessary for creating the album based on the album composition determined in step S509. Subsequently, in step S607, the server 201 determines whether the number of images determined as appropriate as the main images and the sub images through the above-described processing in steps S602 and 603 is sufficient compared with the number of images necessary for composing the album determined in step S606. If the number of images that have become candidates in the determination processing in steps S602 and S603 is greater than the number of images necessary for composing the album (YES in step S607), the processing proceeds to step S608. On the other hand, if the number of candidate images is smaller than the number of necessary images (NO in step S607), the processing proceeds to step S610.

In step S608, the evaluation unit 1008 evaluates the images determined as appropriate as the main images and the sub images via the processing in steps S602 and step S603. The evaluation of the images in the processing in step S608 is performed based on the album composition determined in step S509 (in FIG. 9). According to the present exemplary embodiment, images are evaluated based on the determined design.

For example, the evaluation unit 1008 determines a degree of smile of a person in an image, and attaches a high evaluation if it is an appropriate degree of smile corresponding to the design. For example, if the design is “pop”, the higher the degree of smile in the image, the higher the image is evaluated. If the design is “chic”, the lower the degree of smile is the higher evaluation is attached to the image. If the design is “classic”, a high evaluation is attached to an image with moderate degree of smile. In this way, an image suitable for the determined design may be highly evaluated.

As an example of other evaluation criteria, the image may be evaluated according to a number of persons included in the image. For example, if the design is “pop”, the more the number of persons, the higher evaluation is attached to the image since it gives a cheerful impression. If the design is “chic”, a low evaluation is given to an image which includes many persons (e.g., three or more persons) since it gives a strict impression. If the design is “classic”, a high evaluation is attached to an image which includes three to five persons. In this way, by performing evaluations of the images in accordance with the determined album composition, the images which may help to unify an atmosphere of the album as a whole can be used for the album.

Subsequently, in step S609, the layout unit 1011 lays out the main images in the main image insert frame and the sub images in the sub image insert frame in descending order of evaluation based on the evaluation of the images, and completes the album. Then, the processing ends.

In step S607, if the number of images determined as appropriate as the main images and the sub images is not sufficient for the number of images necessary for composing the album (NO in step S607), in step S610, the determination unit 1004 resets the album composition. In this process, the determination unit 1004 reset the album composition to change the determined number of pages as little as possible. If a number of images insufficient for the main images is equal to or less than a predetermined number (about five frames), the determined number of pages is matched with the number of images. In addition, another example of resetting of the album composition in a case where the number of images insufficient for the main images is equal to or less than the predetermined number, the resetting may be performed to use more sub images without changing the number of images to be used. The resetting may also be performed so that a template in which the main images are not laid out but the sub images are laid out, is used for the album. If the number of images is still not enough, it is determined to use image data including illustrations suitable for the design or messages suitable for a theme of the album as images to be laid out. The image data including illustrations suitable for the design or messages suitable for the theme of the album is stored in advance by the server 201. If the number of the images is insufficient, it may be configured to further perform determination processing illustrated in steps S602 and S603 by changing the condition. By thus performing determination processing by changing the condition, the album can be composed using images each suitable for main images and sub images as many as possible, and suitable for the determined album composition.

Then, in step S611, the server 201 lays out the main images in the main image insert frames and the sub images in the sub image insert frames based on the reset album composition, and completes the album. Accordingly, the album can be created with only the images suitable for the main images and the sub images while maintaining the determined album composition. The album created in a manner as described above may be printed and delivered to the users.

According to the present exemplary embodiment as described above, the user who creates the album can easily create the album suitable for the user who views the album. According to the present exemplary embodiment, for example, if the album viewer is in a close relationship with the album creator, such as relatives or friends, an album that includes more photographs by increasing the number of pages can be automatically created. Since many images can be used, an album can be created in which many images of relatives and friends who have a relationship with the album viewer are included in addition to images of the album viewer and the album creator.

If a degree of intimacy between the album viewer and the album creator is low, an album with a small number of pages can be created. Therefore, an album which includes strangers for the album viewer may not be presented to the album viewer. For a person who is interested in images themselves of the user, a user-like album that takes account of hobby or taste for the viewer can be automatically created by using the album composition with increased number of images, while keeping down the cost by decreasing the number of pages.

The album creator can automatically create a plurality of types of albums, according to persons who view the albums. A plurality of types of automatically created albums is composed so as not to include strangers using appropriate images for each viewer. Therefore, since the album composition is determined to omit unnecessary images for the album viewer, the cost can be saved.

According to the present exemplary embodiment, the example is described that a cover material is determined as an album composition to be determined. In addition, the present exemplary embodiment may be configured to select a gorgeous binding if a binding of the album is designated and a degree of intimacy between the album viewer and the album creator is high, and to select an inexpensive binding when a degree of intimacy between the album viewer and the album creator is low. According to the present exemplary embodiment, it is described that the images to be used in the album are laid out in descending order of evaluation. However, the present exemplary embodiment may be configured to further select images according to a number of images laid out within one page. For example, an image in which the leading character and the album viewer are surely included and an image in which the viewer and the third user are included may be automatically laid out as a first sub image and a second sub image respectively.

If the number of images of the main images or the sub images is less than the determined number of pages or the number of images, the number of pages or the number of images of the album may be reset to match with the number of images of the main images or the sub images.

Further, an example in which the album creator selects an album viewer from a list is described, however, the user who views the album may be identified by inputting a facial image of the album viewer into the server 201, and checking against images in the profile of the user stored in the server 201 using the facial image.

In this case, the user who creates the album can save the effort of designating a user who views the album. In the case of referring to the album on line without printing the album, it may be configured to display the album corresponding to the user who views the album at a real time may be used. In the above-described exemplary embodiment, creation of the album composed of one or a plurality of pages as a content to be created is described. However, as the content to be created, a photo movie composed of images may be used. In the photo movie, the images are displayed in sequence on the display as time passes. In a template for creating the photo movie, the image insertion frame is set on a time axis for displaying the images inserted into the image insertion frames in sequence on the display as time passes. The image insertion frame may change its position, size, shape, lightness, color saturation, and hue as time passes, and have effects of enlargement, reduction, movement, rotation, gradual display, and gradual disappearance.

The image insertion frame, similar to the above-described exemplary embodiment, may include a main image insertion frame and a sub image insertion frame. The main image insertion frame may be displayed longer time or displayed in an enlarged size so as to be distinguished, than an image inserted into the sub image insertion frame. Selection of images to be inserted into the main image insertion frame and the sub image insertion frame is similar to the above-described exemplary embodiments.

According to the above-described exemplary embodiments, an album can be automatically created according to a relationship between a user and a person.

The embodiment can also be realized by a computer of a system or apparatus (or devices such as a CPU, a micro processing unit (MPU), and/or the like) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a non-transitory computer-readable medium).

While the present disclosure has been described with reference to exemplary embodiments, it is to be understood that the disclosure is not limited to the disclosed exemplary embodiments. The scope of the following claims is to be accorded the broadest interpretation so as to encompass all modifications, equivalent structures, and functions.

What is claimed is:

1. An information processing apparatus for creating an album, the information processing apparatus comprising:
a relationship acquisition unit configured to acquire a relationship between a user and another person; and
a determination unit configured to determine at least one of a design, a number of pages, a number of images, and a binding of the album, with at least a relationship between the user and the other person as a condition.

2. The information processing apparatus according to claim 1, further comprising:
a selection unit configured to select an image to be used in the album, with at least a relationship between the user and the other person as a condition; and
a layout unit configured to lay out the image selected by the selection unit based on at least one of the design, the number of pages, the number of images, and the binding determined by the determination unit.

3. The information processing apparatus according to claim 1, further comprising:
a classification unit configured to classify the other person into one or more groups, according to a relationship between the user and the other person,
wherein the determination unit determines at least one of a design, a number of pages, a number of images, and a binding, for each of the groups.

4. The information processing apparatus according to claim 3, further comprising:
a selection unit configured to select an image to be used in an album, with at least a relationship between the user and the other person as a condition; and
wherein the selection unit selects an image that includes a different other person who belongs to a group into which the other person is classified.

5. The information processing apparatus according to claim 1, further comprising:
an intimacy acquisition unit configured to acquire a degree of intimacy between the user and the other person,
wherein the determination unit determines at least one of a design, a number of pages, a number of images, and a binding with at least the degree of intimacy as a condition.

6. The information processing apparatus according to claim 5, wherein the degree of intimacy is based on at least one of numbers of times of sending and receiving of messages between persons or a number of evaluations to an image.

7. The information processing apparatus according to claim 5, wherein the determination unit, if the degree of intimacy is higher than a predetermined value, determines a number of pages so that a number of pages of an album is greater than that in a case where the degree of intimacy is lower than the predetermined value.

8. The information processing apparatus according to claim 5, further comprising:
a selection unit configured to select an image to be used in an album, with at least a relationship between the user and the other person as a condition,
wherein the selection unit selects an image that includes another person who has high degree of intimacy with the other person.

9. The information processing apparatus according to claim 1, further comprising:
a selection unit configured to select an image to be used in an album, with at least a relationship between the user and the other person as a condition,
wherein the relationship acquisition unit acquires a relationship between the user and a different other person and a relationship between the other person and the different other person, and
wherein the selection unit selects an image to be used in an album, with at least the relationship between the user and the different other person and the relationship between the other person and the different other person.

10. The information processing apparatus according to claim 1, further comprising a template acquisition unit configured to acquire a template having an image insertion frame based on at least one of the design, the number of pages, the number of images, and the binding determined by the determination unit.

11. The information processing apparatus according to claim 1, further comprising a resetting unit configured, if images to be used in the album are short in the number of pages or the number of images determined by the determination unit, to reset the number of pages or the number of images.

12. A method for control of an information processing apparatus for creating an album, the method comprising:
acquiring a relationship between a user and another person; and
determining at least one of a design, a number of pages, a number of images, and a binding of the album, with at least a relationship between the user and the other person as a condition.

13. A non-transitory computer readable storage medium storing a program for causing a computer to execute a method according to claim 12.
